(19) United States
(12) Patent Application Publication
(10) Pub. No.: US 2024/0132330 A1
(43) Pub. Date: Apr. 25, 2024

(54) MOTOR CONTROL ARCHITECTURE OF AUTOMATED CRANES

(71) Applicant: DELTA ELECTRONICS, INC., Taoyuan City (TW)

(72) Inventors: Huan-Chang CHEN, Taoyuan City (TW); Po-Jen KO, Taoyuan City (TW); Chun-Ju WU, Taoyuan City (TW); Lon-Jay CHENG, Taoyuan City (TW); Wan-Ping CHEN, Taoyuan City (TW); Chih-Yuan CHANG, Taoyuan City (TW)

(21) Appl. No.: 18/382,033

(22) Filed: Oct. 18, 2023

Related U.S. Application Data
(60) Provisional application No. 63/418,200, filed on Oct. 21, 2022.

(30) Foreign Application Priority Data
Sep. 4, 2023 (CN) 202311138214.0

(51) Int. Cl. B66C 13/48; B66C 13/06; H02P 5/50

(52) U.S. Cl. CPC B66C 13/48; B66C 13/063; H02P 5/50; B66C 17/00

(57) ABSTRACT

Motor control architecture including a travel, a hoist, and a controller is disclosed. The travel disposed on a main rail having an auxiliary-encoder includes a master-driver and a slave-driver for driving two motors. Each motor has a main-encoder. The hoist drives a rope and calculates a rope length continuously. The controller calculates an anti-sway position command based on the rope-length and a position command. The two drivers perform a full closed-loop computation based on a feedback of one main-encoder, a feedback of the auxiliary-encoder, and the anti-sway position command. Wherein, the master-driver controls one motor based on a speed command generated by the full closed-loop computation and the slave-driver follows the speed command and a torque command of the master-driver to drive another motor; or the two drivers compensate the torque command based on an error value between the feedback of one main-encoder and the feedback of the auxiliary-encoder.

### CROSS-REFERENCE TO RELATED APPLICATION

This patent application claims the benefit of U.S. Provisional Patent Application No. 63/418,200, filed Oct. 21, 2022, which is incorporated by reference herein.

### BACKGROUND OF THE DISCLOSURE

### Technical Field

The disclosure relates to a control architecture of cranes, and particularly to a motor control architecture of automated cranes.

### Description of Related Art

Cranes, such as Bridge Cranes or Gantry Cranes, are commonly used for industrial assembly transportation or harbot container lifting. Due to the technological developments, the operations for the cranes transform from technician's manual operations into semi-automatic controls or fully automatic controls.

According to the technical transformation, it is a huge matter about how to implement the prior solutions implemented by the technician's manual operations on the automatic crane controlling.

For example, traditional crane technician operates the crane by manual inching approach in order for the crane and the hanged cargo to move to a target position synchronously, so that the cargo-swaying is eliminated. However, how to implement the above solution on the automated cranes is a difficult problem.

For another example, to achieve precise positioning, traditional crane technician needs to operate the crane to move to a position near the designated position and then operate the crane by the manually inching approach for the crane to slowly reach the designated position. However, how to implement the above solution on the automated cranes is a difficult problem as well.

For another example, due to the long-span structure, the wheels of the two sides of the traditional gantry crane may be asynchronous, so that the traditional gantry crane is accompanied with a flexible mechanism for basic structural anti-skew control. However, using the flexible mechanism to implement the anti-skew control may easily cause vibration to the crane, so that a better solution is required.

Therefore, the present disclosure provides a motor control architecture of automated cranes, which may solve the aforementioned problems and is suitable for both bridge cranes and gantry cranes.

### SUMMARY OF THE DISCLOSURE

The present disclosure is directed to a motor control architecture of automated cranes, which may provide an anti-skew control and a full closed-loop control under the automatic control architecture of the cranes.

In one of the exemplary embodiments, the motor control architecture of the present disclosure includes:
a travel disposed across a main rail, comprising a master driver and a slave driver of respectively controlling a master motor and a slave motor for enabling the travel to move on the main rail along an X-axis direction, wherein an axle of the master motor and the slave motor respectively comprises a main encoder, and an auxiliary encoder is arranged with respect to the main rail;
a trolley disposed on a trolley rail that is arranged upon the travel, comprising a trolley driver of controlling a trolley motor for enabling the trolley to move on the trolley rail along a Y-axis direction;
a hoist arranged at one side of the trolley, comprising a hoist driver of driving a hoist motor for enabling a rope on a hoist mechanism connected to the hoist motor to rise and fall along a Z-axis direction and continuously calculating a rope length information of the rope;
an HMI, configured to receive an external operation to input a target position; and
a controller connected to the master driver, the slave driver, the trolley driver, the hoist driver, and the HMI, configured to perform a path planning process to generate a position command based on the target position, and computing an anti-sway position command based on the rope length information in accompanying with the position command;
wherein the master driver and the slave driver are configured to respectively perform a full closed-loop computation based on the anti-sway position command, a position feedback of one of the two main encoders, and an auxiliary position feedback of the auxiliary encoder;
wherein the master driver is configured to control the master motor to rotate based on a speed command generated by the full closed-loop computation and a torque command and the slave driver is configured to follow the speed command and the torque command of the master driver to control the slave motor to rotate; or, the master driver and the slave driver are configured to respectively regard a position error value of the position feedback of one of the two main encoders and the auxiliary position feedback of the auxiliary encoder to be a source of a PID control process to compensate the torque command to generate a compensated torque command, and respectively control the master motor and the slave motor to operate based on the compensated torque command.

In another one of the exemplary embodiments, the motor control architecture of the present disclosure includes:
a travel disposed across a main rail, comprising a travel driver of controlling both a master motor and a slave motor for enabling the travel to move on the main rail along an X-axis direction, wherein an axle of the master motor comprises a main encoder, and the main rail comprises an auxiliary encoder;
a trolley arranged on a trolley rail upon the travel, comprising a trolley driver of controlling a trolley motor for enabling the trolley to move on the trolley rail along a Y-axis direction;
a hoist arranged at one side of the trolley, comprising a hoist driver of driving a hoist motor for enabling a rope on a hoist mechanism connected to the hoist motor to rise and fall along a Z-axis direction and continuously calculating a rope length information of the rope;
an HMI, configured to receive an external operation to input a target position; and
a controller connected to the travel driver, the trolley driver, the hoist driver, and the HMI, configured to perform a path planning process to generate a position command based on the target position, and computing an anti-sway position command based on the rope length information in accompanying with the position command;
wherein the travel driver is configured to perform a full closed-loop computation based on the anti-sway position command, a position feedback of the main encoder, and a travel auxiliary position feedback of the auxiliary encoder, and control both the master motor and the slave motor based on a speed command and a torque command generated by the full closed-loop computation.

Comparison with related art, the present disclosure firstly computes a position command with the anti-sway control effect, then utilizes the position command, the position feedback of the master motor of the travel, the position feedback of the slave motor of the travel, and the position feedback of the auxiliary encoder to perform the full closed-loop control, and then performs the anti-skew control to the master motor and the slave motor through a torque distribution control approach or a torque compensation control approach, so as to optimize the control architecture of the automated cranes.

### BRIEF DESCRIPTION OF THE DRAWINGS

FIG. 1A is a schematic diagram of bridge cranes according to the present disclosure.

FIG. 1B is a schematic diagram of gantry cranes according to the present disclosure.

FIG. 2 is a schematic diagram showing the moving path of the crane as well as the anti-sway control architecture according to the present disclosure.

FIG. 3 is a schematic diagram showing the arrangement of the auxiliary encoder disposed on the rail as well as the full closed-loop control according to the present disclosure.

FIG. 4A is a schematic diagram showing a first embodiment of the crane architecture according to the present disclosure.

FIG. 4B is a schematic diagram showing a second embodiment of the crane architecture according to the present disclosure.

FIG. 5 is a block diagram showing a first embodiment of the crane architecture according to the present disclosure.

FIG. 6 is a block diagram showing a second embodiment of the crane architecture according to the present disclosure.

FIG. 7 is a block diagram showing a third embodiment of the crane architecture according to the present disclosure.

FIG. 8 is a block diagram showing a fourth embodiment of the crane architecture according to the present disclosure.

FIG. 9 is a block diagram showing a fifth embodiment of the crane architecture according to the present disclosure.

### DETAILED DESCRIPTION OF THE DISCLOSURE

In cooperation with the attached drawings, the technical contents and detailed description of the present disclosure are described hereinafter according to multiple embodiments, being not used to limit its executing scope. Any equivalent variation and modification made according to appended claims is all covered by the claims claimed by the present disclosure.

The present disclosure provides a motor control architecture of cranes, which may be applied for both bridge cranes and gantry cranes to optimize the manual operations for the traditional cranes. More specifically, the present disclosure utilizes the drivers of the Travel, the Trolley, and the Hoist of the cranes to control multiple motors of the cranes to implement the technical effects including anti-sway control, full closed-loop control, and anti-skew control, etc. to optimize the motor control architecture of the automated cranes.

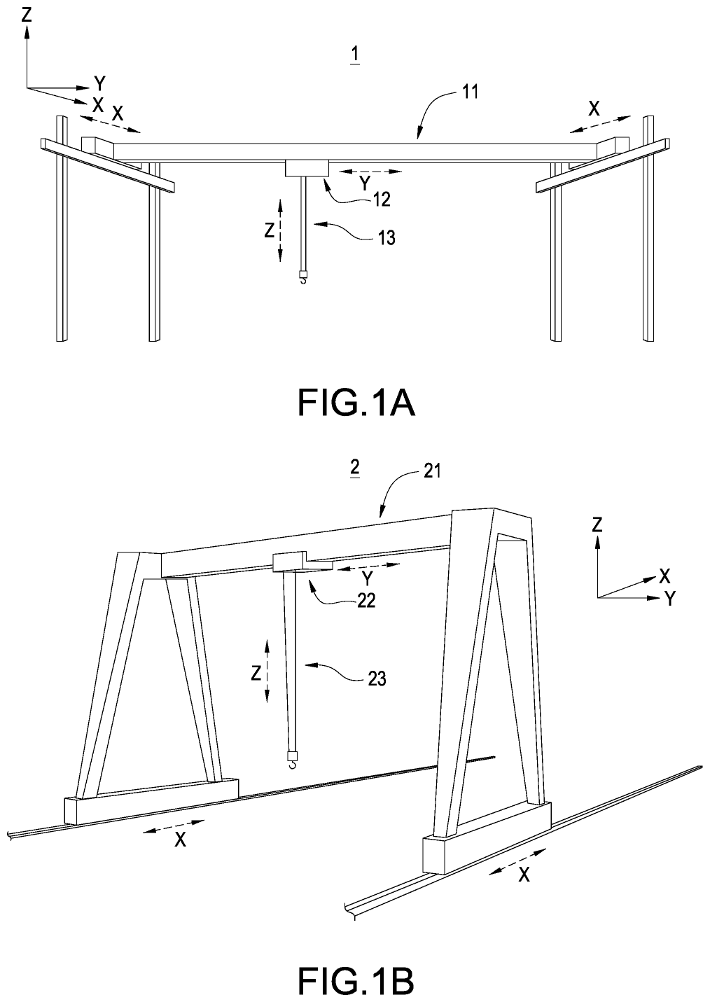

Please refer to FIG. 1A and FIG. 1B, wherein FIG. 1A is a schematic diagram of bridge cranes according to the present disclosure, FIG. 1B is a schematic diagram of gantry cranes according to the present disclosure.

As shown in FIG. 1A, a bridge crane 1 includes a travel 11, a trolley 12, and a hoist 13, wherein the travel 11 is disposed across a main rail and moves for a long trip along an X-axis direction, the trolley 12 is disposed on a trolley rail which is arranged on the travel 11 and moves for a short trip along a Y-axis direction, and the hoist 13 is arranged at one side of the trolley 12 and controls a hoist motor so that a rope on a hoist mechanism brought by the hoist motor may stretch to rise and fall along a Z-axis direction. According to the movements and operations of the travel 11, the trolley 12, and the hoist 13, cargos' hanging and transportation may be implemented by the bridge crane 1. As shown in FIG. 1B, a gantry crane 2 is similar to the bridge crane 1 which includes a travel 21, a trolley 22, and a hoist 23, where the travel 21 is disposed across a main rail and moves for a long trip along an X-axis direction, the trolley 22 is disposed on a trolley rail which is arranged upon the travel 11 and moves for a short trip along a Y-axis direction, and the hoist 23 is arranged at one side of the trolley 12 and controls a hoist motor so that a rope on a hoist mechanism brought by the hoist motor may stretch to rise and fall along a Z-axis direction. Two sets of wheel-axles (respectively controlled by different motors) of the travel 21 of the gantry crane 2 encounter a long-span; therefore, the gantry crane 2 should consider, while moving, not only the anti-sway control and the full closed-loop control but also the anti-skew control for its two wheel-axles respectively controlled by different motors and disposed across different tracks of the main rail.

In the present disclosure, the anti-sway control may restrict the cargo hanged by the hoist 13 or 23 to be swaying while transportation; the full closed-loop control may restrict the displacement caused by the slippage of the travel wheel-axles and the trolley wheel-axles on the rails to reach precise positioning; the anti-skew control may restrict the position offset between two wheel-axles of the travel 21 of the gantry crane 2 having a long-span to reduce the vibration and instability of the travel 21 while moving.

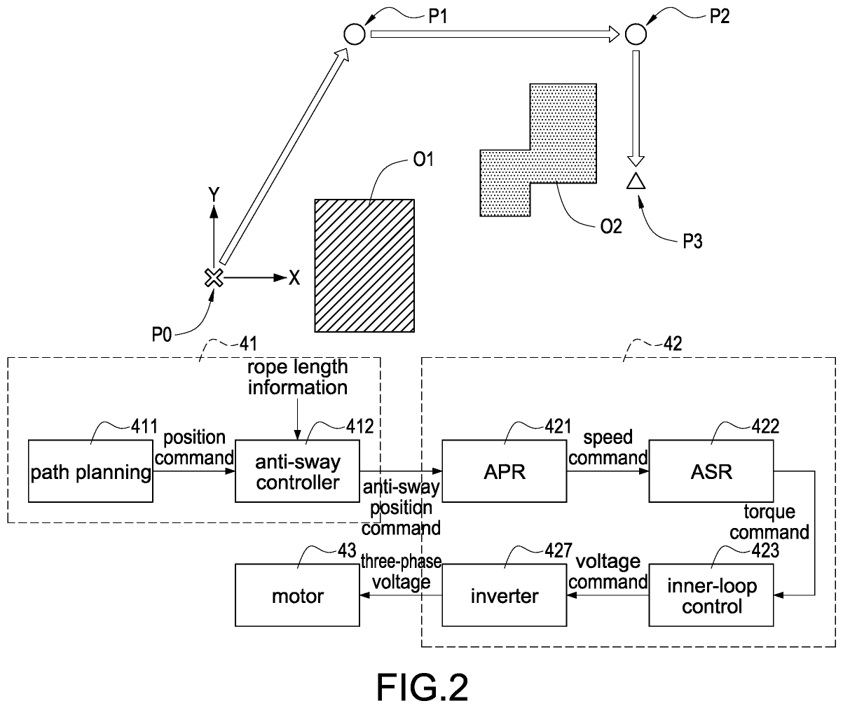

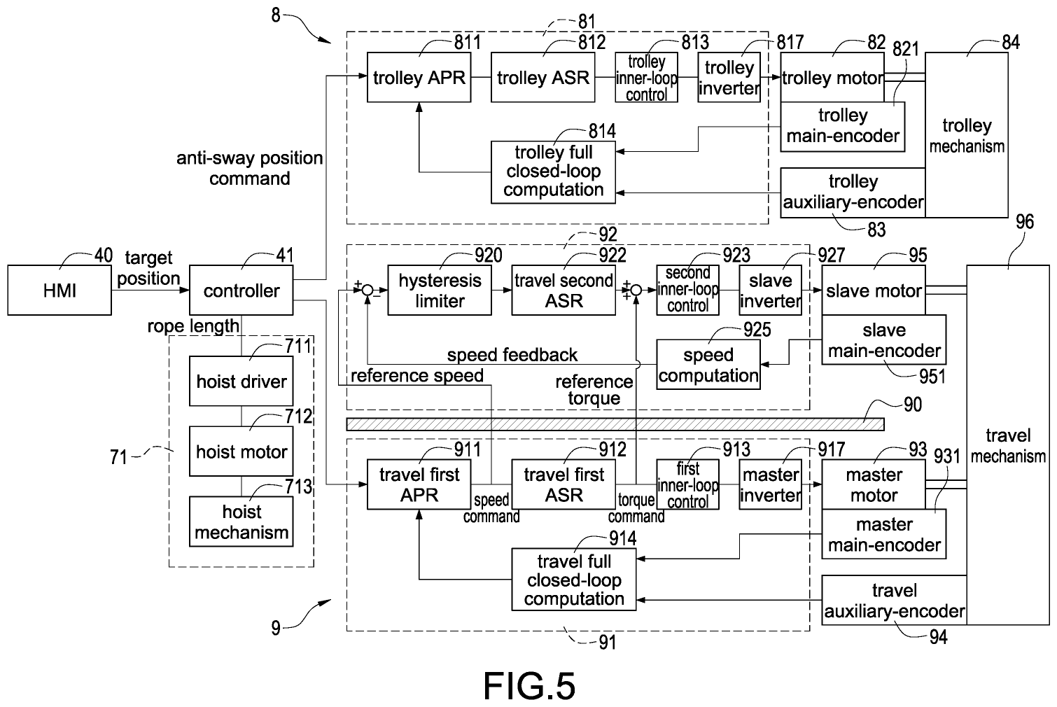

Please refer to FIG. 2, which is a schematic diagram showing the moving path of the crane as well as the anti-sway control architecture according to the present disclosure. In addition to the crane, the control architecture of the present disclosure is implemented in accompany with a human machine interface (HMI) and a controller (such as the HMI and the controller 41 as shown in FIG. 5).

A user may operate the HMI 40 to set a target position P3 for the cargo hanged on the crane, collect the position information of the obstacles (such as the position information of the forbidden region O1 and the obstacle O2 as shown in FIG. 2), and transmits the above information to the controller 41. The controller 41 obtains the current position P0 of the crane (or the cargo) and performs a position to position (P2P) calculation based on the current position P0, the target position P3 set by the user, and the information of the forbidden region O1 and the obstacle O2 to generate optimized relay positions P1 and P2. In addition, the controller 41 performs a path planning process and an anti-sway control based on the current position P0, the relay positions P1 and P2, and the target position P3 to generate a cyclic synchronous position (CSP) command for the components (including a travel driver and a trolley driver) of each crane to be controlled.

After receiving the above CSP command, each motor driver of each crane may respectively control the corresponding motor (including a master motor, a slave motor, and a trolley motor) to rotate, so that the cargo may be moved from the current position P0, passing through the relay positions P1 and P2, to the target position P3, along the moving path planned and calculated by the controller 41.

It should be noted that, when performing the path planning, the controller 41 takes the forbidden region O1 and the obstacle O2 in the environment under consideration. Therefore, when the crane conveys the cargo from the current position P0, passing through the relay positions P1 and P2, to the target position P3, the cargo can be prevented from entering into the forbidden region O1 and colliding with the obstacle O2.

It should be mentioned that, in the embodiment of FIG. 2, the lateral movement of the cargo (e.g., moves from the relay position P1 to the relay position P2) is implemented by the movement of the travel, the straight movement (e.g., moves from the relay position P2 to the target position P3) is implemented by the movement of the trolley, and the diagonal movement (e.g., moves from the current position P0 to the relay position P1) is implemented by the movement of both the travel and the trolley.

The motor control architecture of the present disclosure includes the controller 41 and multiple drivers 42. In particularly, each of the travel and the trolley of the present disclosure respectively includes one or more drivers for controlling its corresponding motor(s), where the drivers 42 at least include a master driver of the travel, a slave driver of the travel, and a trolley driver of the trolley, etc. For the sake of understanding, only one driver 42 is depicted in FIG. 2 for an example, but the quantity of the driver is not limited to what is disclosed in FIG. 2.

In one of the exemplary embodiments, the controller 41 may be, for example but not limited to, a programmable logic controller (PLC), a central process unit (CPU), a micro control unit (MCU), a field programmable gate array (FPGA), a system on chip (SoC), etc., or a combination thereof.

As shown in FIG. 2, the controller 41 includes a path planning module 411 and an anti-sway controller 412. The path planning module 411 obtains the current position P0 and the target position P3 set by the user and performs the path planning process based on the current position P0 and the target position P3 to generate the corresponding position command. The anti-sway controller 412 continuously obtains the current rope length information from the hoist driver of the crane and generates an anti-sway position command based on the position command and the rope length information. If each driver 42 of the crane respectively controls each motor to rotate according to the anti-sway position command, the crane may move the cargo to the target position P3 while preventing the cargo from excessive swaying.

It should be mentioned that the anti-sway position command is a CSP command, wherein the controller 41 synchronously issues the CSP command to each driver 42 of the crane. Therefore, the present disclosure may implement the synchronous control for multiple motors of the crane.

As shown in FIG. 2, any driver 42 of the crane may include an automatic position regulator (APR) 421, an automatic speed regulator (ASR) 422, an inner-loop control module 423, and an inverter circuit 427. The APR 421 receives the anti-sway position command from the controller 41 and processes the anti-sway position command to generate a speed command correspondingly. The ASR 422 receives the speed command generated by the APR 421 and processes the speed command to generate a torque command correspondingly. The inner-loop control module 423 receives the torque command generated by the ASR 422 and processes the torque command to generate a voltage command correspondingly, and the inverter circuit 427 is utilized to actually output a three-phase voltage to a corresponding motor 43 to control the rotation of the motor 43.

In this embodiment, the controller 41 has considered the target position and the rope length information of the rope while generating the anti-sway position command. As a result, when multiple drivers 42 of the crane respectively control multiple motors 43 to rotate correspondingly, the crane may restrict the cargo from swaying while conveying the cargo from the current position to the target position. In sum, the anti-sway control is implemented.

It should be mentioned that the controller 41 and the driver 42 may be implemented by electronic circuits which recorded with computer-executable program codes. When the controller 41 and the driver 42 respectively execute the program codes, the controller 41 and the driver 42 may create multiple modules such as the aforementioned path planning module 411, the anti-sway controller 412, the APR 421, the ASR 422, and the inner-loop control module 243 inside of the controller 41 and/or the driver 42 based on the requirement for the corresponding functions. In addition, the inverter circuit 427 should be provided accordingly. In other words, the aforementioned modules 411-412 and 421-423 may be software modules implemented by electronic circuits in accompanying with program codes but not limited thereto.

In another embodiment, the controller 41 and the driver 42 may implement the aforementioned modules 411-412 and 421-423 through hardware while the inverter circuit 427 is also provided.

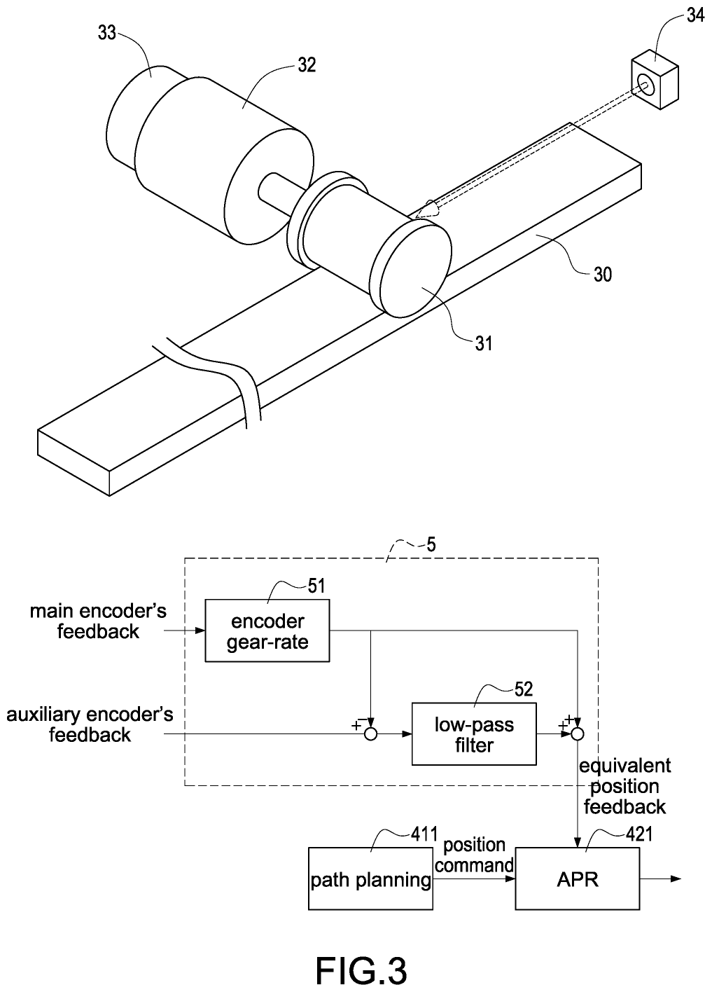

Please refer to FIG. 3, which is a schematic diagram showing the arrangement of the auxiliary encoder disposed on the rail as well as the full closed-loop control according to the present disclosure.

In the present disclosure, please refer to FIG. 1A, FIG. 1B, and FIG. 3 at the same time, the travels 11, 21 and the trolleys 12, 22 of the cranes 1, 2 respectively have two symmetrical wheel-axles. FIG. 3 shows one of the two symmetrical wheel-axles of the travels 11, 21 or the trolleys 12, 22. As shown in FIG. 3, the wheel-axle at least includes a wheel 31, a motor 32 controlling the wheel 31 to rotate, and a main encoder 33 of the motor 32. The wheel 31 is disposed on a rail 30 (e.g., the rail of the main rail or the trolley rail). The motor 32 controls the wheel 31 to move on the rail 30. The main encoder 33 detects the current position of the rotated motor 32 and continuously generates position feedback information of the motor 32.

As shown in FIG. 3 one side of the rail 30 is arranged with an auxiliary encoder 34. In one of the exemplary embodiments, the auxiliary encoder 34 may be, for example but not limited to, an IR rangefinder or a laser rangefinder. The auxiliary encoder 34 continuously detects the position of the wheel 31 on the rail 30, i.e., detects the current position of the travels 11, 21 or the trolleys 12, 22 and generate auxiliary position feedback information correspondingly.

In the present disclosure, each driver 42 respectively performs the full closed-loop control according to the rope length information of rope of the hoist, the position feedback information of the one or more main encoders 33 with respect to the motors 32, and the auxiliary position feedback information of the auxiliary encoder 34, so as to adjust the positioning error caused by the slippage of the wheel-axles to reach the precise positioning effect.

As shown in FIG. 3, the full closed-loop control of the present disclosure is implemented by a full closed-loop computation module 5. The full closed-loop computation module 5 may be implemented by software or hardware, and the full closed-loop computation module 5 includes an encoder gear-rate computation module 51 and a low-pass filter 52 due to the functions required by the full closed-loop control. In the present disclosure, the encoder gear-rate computation module 51 and the low-pass filter 52 may be hardware modules or software modules implemented by electronic circuits in accompanying with program codes.

In the present disclosure, please refer to FIG. 3, each driver 42 may optionally execute the function of the full closed-loop computation module 5. In particularly, the full closed-loop computation module 5 receives main encoder's feedback (i.e., the position feedback information) from the main encoder 33 (including the main encoder corresponding to the master motor, the main encoder corresponding to the slave motor, and the main encoder corresponding to the trolley motor) by the encoder gear-rate computation module 51. In addition, the encoder gear-rate computation module 51 calculates a ratio of the pulse feedback of the auxiliary encoder 34 and the resolution of the corresponding main encoder while the motor rotates.

On the other hand, the full closed-loop computation module 5 receives auxiliary encoder's feedback (i.e., the auxiliary position feedback information) through the low-pass filter 52, calculates a difference value between the auxiliary encoder's feedback and the ratio, and performs a filtering process to this difference value. In addition, the low-pass filter 52 adds the difference value of the filtering process with the above ratio to generate an equivalent position feedback. In the present disclosure, each driver 42 generates a speed command based on the equivalent position feedback generated by the full closed-loop computation module 5 (and also generates a torque command correspondingly) to control a corresponding motor 43 to rotate. Therefore, the crane may adjust, through the control of the drivers 42, the positioning error caused by the slippage of the wheel-axles to reach the precise positioning effect.

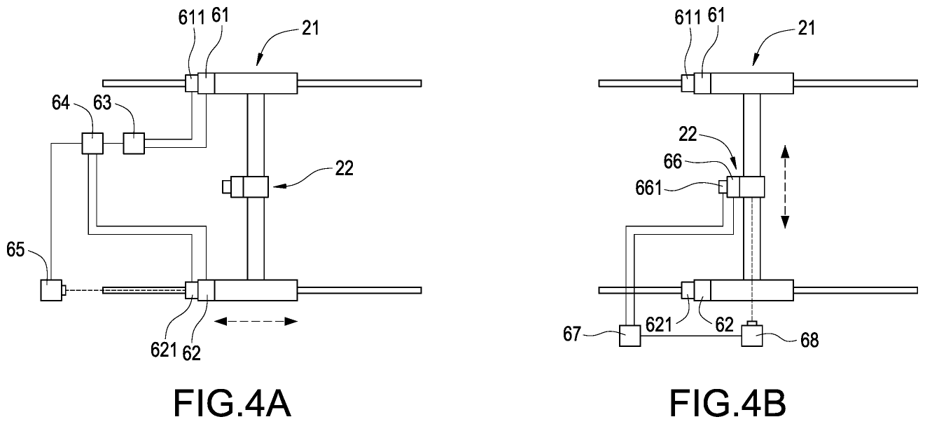

Please refer to FIG. 4A, which is a schematic diagram showing a first embodiment of the crane architecture according to the present disclosure. As shown in FIG. 4A, the crane includes a travel 21 disposed on the main rail and a trolley 22 disposed on the trolley rail where the trolley rail is arranged upon the travel 21. The travel 21 includes a first wheel set controlled by a master motor 61 and a second wheel set controlled by a slave motor 62, wherein the travel 21 is disposed across the main rail through the first wheel set and the second wheel set. The first wheel set and the second wheel set respectively include at least one wheel, but not limited thereto.

More specifically, the main rail includes a first rail provided for the first wheel set to move and a second rail provided for the second wheel set to move, wherein the first rail and the second rail are parallel with each other and at least one of the first rail and the second rail is arranged with an auxiliary encoder 65.

In one of the exemplary embodiments, the auxiliary encoder 65 (also called a master auxiliary-encoder) is arranged with respect to the first rail to detect the first wheel set to generate a master auxiliary-position feedback. In one of the exemplary embodiments, the auxiliary encoder 65 (also called a slave auxiliary-encoder) is arranged with respect to the second rail to detect the second wheel set to generate a slave auxiliary-position feedback. In one of the exemplary embodiments, the auxiliary encoder 65 includes a master auxiliary-encoder being arranged with respect to the first rail and a slave auxiliary-encoder being arranged with respect to the second rail, where the master auxiliary-encoder generates the master auxiliary-position feedback and the slave auxiliary-encoder generates the slave auxiliary-position feedback.

As shown in FIG. 4A, the master motor 61 includes a master main-encoder 611 which generates the position feedback based on the current rotation position of the master motor 61. The slave motor 62 includes a slave main-encoder 621 which generates the position feedback based on the current rotation position of the slave motor 62. The motor control architecture of the present disclosure further includes a master driver 63 that controls the master motor 61 and receives the position feedback from the master main-encoder 611 and a slave driver 64 that controls the slave motor 62 and receives the position feedback from the slave main-encoder 621. By utilizing the master driver 63 to control the master motor 61 and the slave driver 64 to control the slave motor 62, the motor control architecture of the present disclosure may implement the anti-skew control while controlling the crane to move.

Please refer to FIG. 4B at the same time, wherein FIG. 4B is a schematic diagram showing a second embodiment of the crane architecture according to the present disclosure. As shown in FIG. 4B, the trolley 22 includes a trolley wheel set being controlled by a trolley motor 66. The trolley wheel set is disposed on the trolley rail which is arranged upon the travel 21. A trolley auxiliary-encoder 68 is arranged with respect to the trolley rail to detect the trolley wheel set and generate an auxiliary position feedback of the trolley 22. The trolley wheel set at least includes one trolley wheel but not limited thereto.

In one of the exemplary embodiments, the trolley wheel set includes a single trolley wheel to be controlled by a single trolley motor 66. In one of the exemplary embodiments, the trolley wheel set includes two trolley wheels each controlled by one of two trolley motors 66. In one of the exemplary embodiments, the trolley wheel set includes two trolley wheels which are controlled by a single trolley motor 66. However, the above descriptions are only few embodiments of the present disclosure, but not limited thereto.

As shown in FIG. 4B, the trolley motor 66 includes a trolley main-encoder 661 that generates the position feedback based on the current rotation position of the trolley motor 66. The motor control architecture of the present disclosure further includes a trolley driver 67 that controls the trolley motor 66 and receives the position feedback of the trolley main-encoder 661. In the present disclosure, the trolley driver 67 controls the trolley motor 66 based on the position feedback of the trolley main-encoder 661 and the auxiliary position feedback of the trolley auxiliary-encoder 68 to implement the automated control.

As mentioned above, in the present disclosure, the controller 41 generates the CSP command and simultaneously issues the CSP command to multiple drivers of the travel, the trolley, and the hoist, so as to implement the anti-sway control, the full closed-loop control, and the anti-skew control.

To achieve the anti-skew control for the two wheel-axles of the travel, the interaction between the master driver and the slave driver of the travel is important. The detailed descriptions are provided below.

Please refer to FIG. 5, which is a block diagram showing a first embodiment of the crane architecture according to the present disclosure. The motor control architecture of the present disclosure includes a human machine interface (HMI) 40, a controller 41, a hoist 71, a trolley 8, and a travel 9. The travel 9 includes a master motor 93, a slave motor 95, a master driver 91 that controls the master motor 93, and a slave driver 92 that controls the slave motor 95, wherein the master driver 91 and the slave driver 92 are respectively connected to the controller 41. The two drivers 91, 92 are configured to driver the master motor 93 and the slave motor 95 so that the travel 9 may move on the main rail along an X-axis direction.

As shown in FIG. 5, the master motor 93 includes a master main-encoder 931 and the slave motor 95 includes a slave main-encoder 951. A travel auxiliary-encoder 94 is arranged with respect to the main rail. In this embodiment, the master motor 93, the slave motor 95, and the travel auxiliary-encoder 94 are directly connected to a travel mechanism 96 to control the movement of the travel mechanism 96 and generate corresponding position feedback information.

The trolley 8 includes a trolley motor 82 and a trolley driver 81 that controls the trolley motor 82. The trolley driver 81 is connected to the controller 41 and drivers the trolley motor 82 to rotate, so that the trolley may move on the trolley rail along a Y-axis direction. The trolley motor 82 includes a trolley main-encoder 821. A trolley auxiliary-encoder 83 is arranged with respect to the trolley rail. In this embodiment, the trolley motor 82 and the trolley auxiliary-encoder 83 are directly connected to a trolley mechanism 84 to control the movement of the trolley mechanism 84 and generate corresponding auxiliary position feedback information.

The hoist 71 is arranged at one side of the trolley 8 and includes a hoist driver 711 that controls a hoist motor 712. The hoist driver 711 controls the hoist motor 712 to drive a rope on a hoist mechanism 713 to rise and fall along a Z-axis direction, wherein the hoist mechanism 713 is connected to the hoist motor 712. In addition, the hoist driver 711 continuously calculates the rope length information of the rope during the rope is controlled to be rising and falling.

The HMI 40 is configured to receive an external operation from the user to input the target position of the cargo hanged on the crane.

The controller 41 is connected to the HMI 40, the hoist driver 711 of the hoist 71, the trolley driver 81 of the trolley 8, and the master driver 91 and the slave driver 92 of the travel 9. In the present disclosure, the controller 41 receives the target position set by the user from the HMI 40 and receives the rope length information calculated by the hoist driver 711 from rope of the hoist 71. Next, the controller 41 performs the path planning process based on the target position to generate a corresponding position command, and then the controller 41 computes the anti-sway position command based on the rope length information in accompanying with the position command. As mentioned above, the anti-sway position command computed by the controller 41 is a CSP command, which may be utilized to synchronously control the trolley motor 82, the master motor 93, and the slave motor 95.

In the present disclosure, the master driver 91 and the slave driver 92 of the travel 9 performs the full closed-loop computation based on the anti-sway position command being received, the position feedback of one of the two main encoders 931, 951, and the auxiliary position feedback of the travel auxiliary-encoder 94. Therefore, the motor control architecture of the present disclosure may implement the precise positioning effect while the controller 41, the master driver 91, and the slave driver 92 control motors 93, 95 of the travel 9 to move.

It should be mentioned that, to perform the anti-skew control to the two wheel-axles of the travel 9, the controller 41 may perform either a torque distribution control or a torque compensation control to the master driver 91 and the slave driver 92 of the travel 9. The torque distribution control and the torque compensation control are respectively discussed below.

Under a torque distribution control mode, the master driver 91 of the travel 9 firstly generates a corresponding torque command based on the command generated by the full closed-loop computation (such as the position command or the speed command) and then controls the master motor 93 to rotate based on the torque command. On the other hand, the slave driver 92 of the travel 9 follows the speed command and the torque command of the master driver 91 to control the slave motor 95 to rotate, so as to achieve the anti-skew control for the two wheel-axles of the travel 9 which respectively controlled by the master motor 93 and the slave motor 95.

Under a torque compensation control mode, the master driver 91 and the slave driver 92 of the travel 9 compute a position error value of the position feedback of one of the two main encoders 931, 951 and the auxiliary position feedback of the travel auxiliary-encoder 94, regards the position error value as a source of a proportion-integration-differentiation (PID) control, so as to compensate the torque command being generated. Next, the master driver 91 and the slave driver 92 respectively control the master motor 93 and the slave motor 95 to rotate based on the compensated torque command to achieve the anti-skew control for the two wheel-axles of the travel 9.

FIG. 5 shows the configuration architecture of the master driver 91 and the slave driver 92 under the torque distribution control mode.

As shown in FIG. 5, the master driver 91 and the slave driver 92 have a wired connection or wireless connection with each other through a communication interface 90. The master driver 91 includes a travel first APR 911, a travel first ASR 912, a first inner-loop control module 913, a travel full closed-loop computation module 914, and a master inverter circuit 917.

The travel first APR 911 receives the anti-sway position command from the controller 41, receives the position feedback from the travel full closed-loop computation module 914, and generates the speed command of the master motor 93 based on the anti-sway position command and the position feedback. The travel first ASR 912 receives the speed command from the travel first APR 911 and then generates a torque command correspondingly based on the speed command. The first inner-loop control module 913 receives the torque command from the travel first ASR 912 and then generates a voltage command for controlling the master motor 93 of the travel 9 based on the torque command. The master inverter circuit 917 receives the voltage command from the first inner-loop control module 913 and outputs a corresponding three-phase voltage through the switching of the power component to drive the master motor 93 to rotate.

In the embodiment, the travel 9 performs the function of the travel full closed-loop computation module 914 by the master driver 91. In particularly, the travel full closed-loop computation module 914 receives the master position feedback of the master motor 93 from the master main-encoder 931, receives the auxiliary position feedback of the travel 9 from the travel auxiliary-encoder 94, and generates the position feedback to output to the travel first APR 911 based on the master position feedback and the auxiliary position feedback.

The slave driver 92 includes a hysteresis limiter 920, a travel second ASR 922, a second inner-loop control module 923, a speed computation module 925, and a slave inverter circuit 927. In the embodiment, the slave driver 92 is connected to the master driver 91 through the communication interface 90. The slave driver 92 obtains the speed command generated by the travel first APR 911 to be a reference speed and obtains the torque command generated by the travel first ASR 912 to be a reference torque.

In the embodiment, the speed computation module 925 receives the slave position feedback of the slave motor 95 from the slave main-encoder 951 of the slave motor 95 and generates a corresponding speed feedback based on the slave position feedback.

The hysteresis limiter 920 obtains the reference speed from the master driver 91 through the communication interface 90, obtains the speed feedback from the speed computation module 925, and generates a corresponding second speed command based on the reference speed and the speed feedback. In one of the exemplary embodiments, the hysteresis limiter 920 subtracts the speed feedback from the reference speed to generate the second speed command.

The travel second ASR 922 receives the second speed command from the hysteresis limiter 920 and generates a corresponding second torque command based on the second speed command. The second inner-loop control module 923 obtains the reference torque from the master driver 91 through the communication interface 90, obtains the second torque command from the travel second ASR 922, and controls the slave motor 95 to rotate based on the reference torque and the second torque command. In one of the exemplary embodiments, the second inner-loop control module 923 adds the reference torque and the second torque command to generate a compensated torque command and then generate a voltage command for controlling the slave motor 95 based on the compensated torque command. The slave inverter circuit 927 receives the voltage command from the second inner-loop control module 923 and outputs a corresponding three-phase voltage through the switching of the power component to drive the slave motor 95 to rotate.

In the embodiment of FIG. 5, the trolley driver 81 includes a trolley APR 811, a trolley ASR 812, a trolley inner-loop control module 813, a trolley full closed-loop computation module 814, and a trolley inverter circuit 817. The trolley full closed-loop computation module 814 receives the position feedback of the trolley motor 82 from the trolley main-encoder 821 of the trolley motor 82, receives the auxiliary position feedback of the trolley 8 from the trolley auxiliary-encoder 83, and generates the trolley position feedback to output to the trolley APR 811 based on the position feedback and the auxiliary position feedback.

The trolley APR 811 receives the anti-sway position command from the controller 41, receives the trolley position feedback from the trolley full closed-loop computation module 814, and generates the speed command for the trolley 8 based on the anti-sway position command and the trolley position feedback. The trolley ASR 812 receives the speed command from the trolley APR 811 and generates the torque command for the trolley motor 82 of the trolley 8 based on the speed command. The trolley inner-loop control module 813 receives the torque command from the trolley ASR 812 and generates a voltage command for controlling the trolley motor 82 based on the torque command. The trolley inverter circuit 817 receives the voltage command from the trolley inner-loop control module 813 and outputs a corresponding three-phase voltage through the switching of the power component to drive the trolley motor 82 to rotate.

It should be mentioned that the multiple modules 811-814 of the trolley driver 81, the multiple modules 911-914 of the master driver 91, and the multiple modules 920, 922, 923, 925 of the slave driver 92 may be hardware modules or software modules implemented via electronic circuits in accompanying with program codes.

By utilizing the aforementioned motor control architecture, the controller 41 may implement the anti-sway control and the full closed-loop control when simultaneously controlling the operations of the drivers corresponding to the travel 9, the trolley 8, and the hoist 71. In addition, a torque distribution control type's anti-skew control may also be implemented via allowing the slave driver 92 to follow the speed command and the torque command of the master driver 91.

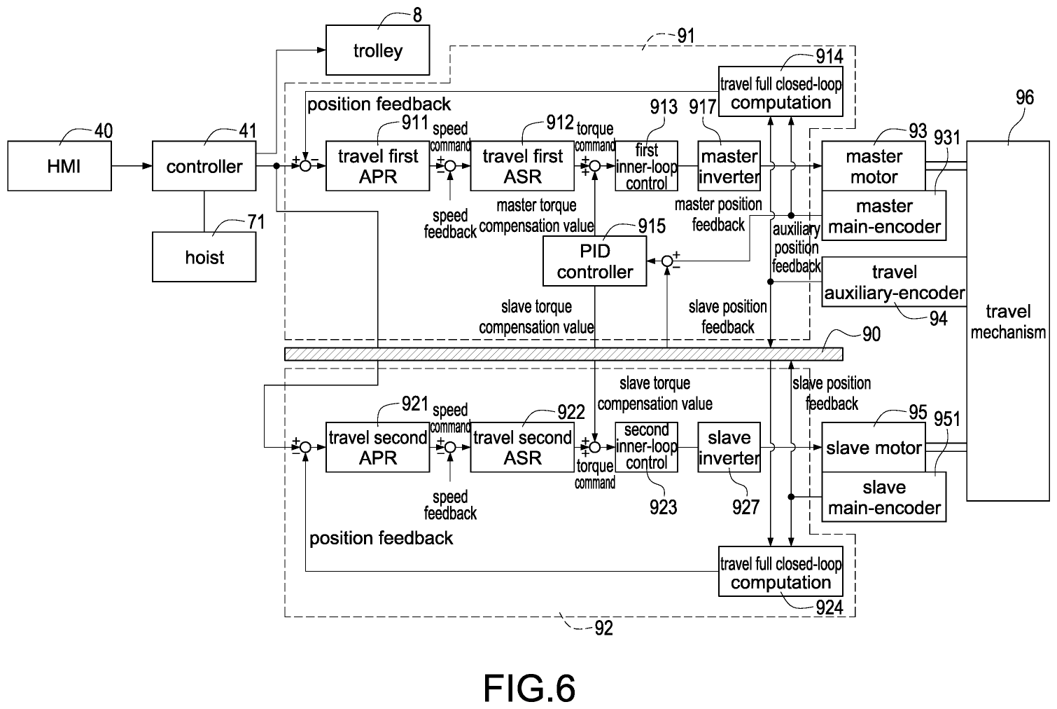

Please refer to FIG. 6, which is a block diagram showing a second embodiment of the crane architecture according to the present disclosure. FIG. 6 shows the configuration architecture of the master driver 91 and the slave driver 92 under the torque compensation control mode.

In the embodiment of FIG. 6, the configuration architecture of the master driver 91 and the slave driver 92 is similar to that of the embodiment as shown in FIG. 5, the difference between the embodiment of FIG. 6 and the embodiment of FIG. 5 is that the master driver 91 of FIG. 6 further includes a PID controller 915 that compensates the torque commands of the master motor 93 and the slave motor 95.

As shown in FIG. 6, the master driver 91 includes a travel first APR 911, a travel first ASR 912, a first inner-loop control module 913, a travel full closed-loop computation module 914, a PID controller 915, and a master inverter circuit 917.

The travel full closed-loop computation module 914 receives the master position feedback of the master motor 93 from the master main-encoder 931, receives the auxiliary position feedback of the travel 9 from the travel auxiliary-encoder 94, and generates a corresponding first position feedback based on the master position feedback and the auxiliary position feedback. The travel first APR 911 receives the anti-sway position command from the controller 41, receives the first position feedback from the travel full closed-loop computation module 914, and generates the speed command of the master motor 93 based on the anti-sway position command and the first position feedback.

The travel first ASR 912 receives the speed command from the travel first APR 911, receives the speed feedback of the master motor 93, and generates the torque command of the master motor 93 based on the speed command and the speed feedback. In one of the exemplary embodiments, the travel first ASR 912 subtracts the speed feedback of the master motor 93 from the speed command generated by the travel first APR 911 to generate a speed error value and then generates the torque command correspondingly according to the speed error value.

The PID controller 915 receives the master position feedback of the master motor 93 from the master main-encoder 931. Also, the PID controller 915 receives the slave position feedback of the slave motor 95 from the slave driver 92 through the communication interface 90. Therefore, the PID controller 915 generates a master torque compensation value for compensating the master motor 93 and a slave torque compensation value for compensating the slave motor 95 based on the master position feedback and the slave position feedback.

The first inner-loop control module 913 receives the torque command of the master motor 93 from the travel first ASR 912, receives the master torque compensation value from the PID controller 915, and controls the master motor 93 to rotate based on the torque command and the master torque compensation value. In one of the exemplary embodiments, the first inner-loop control module 913 adds the torque command generated by the travel first ASR 912 and the master torque compensation value generated by the PID controller 915 to generate a compensated torque command and generates a voltage command for controlling the master motor 93 based on the compensated torque command. The master inverter circuit 917 receives the voltage command from the first inner-loop control module 913 and outputs a corresponding three-phase voltage through the switching of the power component to drive the master motor 93 to rotate.

In the embodiment of FIG. 6, it is unnecessary for the slave driver 92 to follow the speed command and the torque command of the master driver 91. Instead, the slave driver 92 provides, through the communication interface 90, the slave position feedback of the slave motor 95 to the master driver 91 for being computed and then obtains the slave torque compensation value that is computed by the master driver 91.

In particularly, the slave driver 92 includes a travel second APR 921, a travel second ASR 922, a second inner-loop control module 923, a travel full closed-loop computation module 924, and a slave inverter circuit 927. The travel full closed-loop computation module 924 receives the slave position feedback of the slave motor 95 from the slave main-encoder 951, receives the auxiliary position feedback of the travel 9 from the travel auxiliary-encoder 94, and generates a corresponding second position feedback based on the slave position feedback and the auxiliary position feedback.

In the embodiment of FIG. 6, the slave driver 92 obtains the auxiliary position feedback from the master driver 91 through the communication interface 90. However, in another embodiment, the slave driver 92 may be directly connected to the travel auxiliary-encoder 94 to obtain the auxiliary position feedback, and the master driver 91 may obtain the auxiliary position feedback of the travel auxiliary-encoder 94 from the slave driver 92 through the communication interface 90. The configuration relationship of the master driver 91, the slave driver 92, and the travel auxiliary-encoder 94 is not limited to what is disclosed in FIG. 6.

The travel second APR 921 receives the anti-sway position command from the controller 41, receives the second position feedback from the travel full closed-loop computation module 924, and generates the speed command of the slave motor 95 based on the anti-sway position command and the second position command. The travel second ASR 922 receives the speed command from the travel second APR 921, receives the speed feedback of the slave motor 95, and then generates the torque command of the slave motor 95 based on the speed command and the speed feedback of the slave motor 95.

The second inner-loop control module 923 receives the torque command of the slave motor 95 from the travel second ASR 922 and also receives the slave torque compensation value generated by the PID controller 915 from the master driver 91 through the communication interface 90. Next, the second inner-loop control module 923 controls the slave motor 95 to rotate based on the torque command and the slave torque compensation value. In one embodiment, the second inner-loop control module 923 adds the torque command generated by the travel second ASR 922 and the slave torque compensation value generated by the PID controller 915 to generate a compensated torque command and then generates a voltage command for controlling the slave motor 95 based on the compensated torque command. The slave inverter circuit 927 receives the voltage command from the second inner-loop control module 923 and outputs a corresponding three-phase voltage through the switching of the power component to drive the slave motor 95 to rotate.

In the embodiment, the multiple modules 911-915 of the master driver 91 and the multiple modules 921-924 of the slave driver 92 may be hardware modules or software modules implemented by electronic circuits in accompanying with program codes.

By utilizing the above motor control architecture, the controller 41 may implement the anti-sway control and the full closed-loop control while controlling the operations of the drivers corresponding to the travel 9, the trolley 8, and the hoist 71. Also, the motor control architecture may implement the torque compensation type's anti-skew control via utilizing the master driver 91 and the slave driver 92 to control the master motor 93 and the slave motor 95 based on the torque command and the torque compensation value.

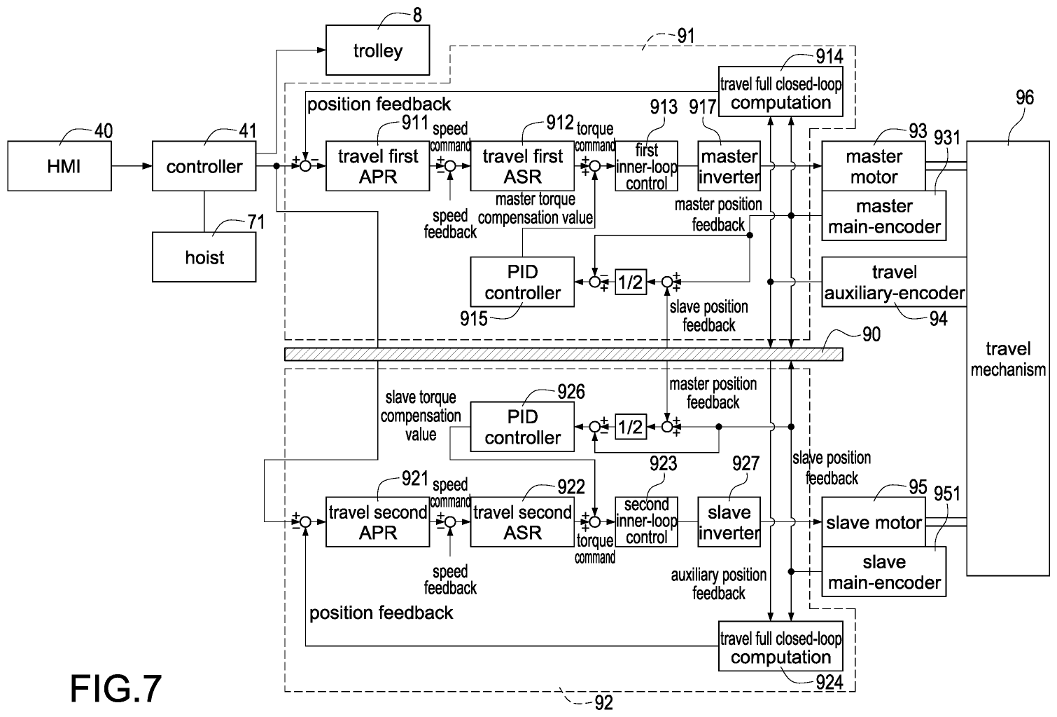

Please refer to FIG. 7, which is a block diagram showing a third embodiment of the crane architecture according to the present disclosure. FIG. 7 shows the configuration architecture of the master driver 91 and the slave driver 92 under the torque compensation control mode.

In the embodiment of FIG. 7, the configuration architecture of the master driver 91 and the slave driver 92 is similar to that of the embodiment of FIG. 6, wherein the difference between the embodiment of FIG. 7 and the embodiment of FIG. 6 is that each of the master driver 91 and the slave driver 92 in FIG. 7 is respectively arranged with one PID controller 915, 926.

As shown in FIG. 7, the master driver 91 includes a travel first APR 911, a travel first ASR 912, a first inner-loop control module 913, a travel full closed-loop computation module 914, a PID controller 915, and a master inverter circuit 917.

The travel full closed-loop computation module 914 receives the master position feedback of the master motor 93 from the master main-encoder 931, receives the auxiliary position feedback of the travel 9 from the travel auxiliary-encoder 94, and generates a corresponding first position feedback based on the master position feedback and the auxiliary position feedback. The travel first APR 911 generates the speed command of the master motor 93 based on the anti-sway position command received from the controller 41 and the first position feedback received from the travel full closed-loop computation module 914. The travel first ASR 912 generates the torque command of the master motor 93 based on the speed command received from the travel first APR 911 and the speed feedback of the master motor 93.

In the embodiment, the master driver 91 receives the master position feedback from the master main-encoder 931 through the PID controller 915 or another module (not shown in FIG. 7), receives the slave position feedback of the slave motor 95 from the slave driver 92 through the communication interface 90, and calculates an average value of the master position feedback and the slave position feedback. In the embodiment, the master driver 91 calculates a position error value of the average value and the master position feedback, and the PID controller 915 generates the master torque compensation value based on the position error value being generated.

The first inner-loop control module 913 receives the torque command of the master motor 93 from the travel first ASR 912, receives the master torque compensation value from the PID controller 915, and controls the master motor 93 to rotate based on the torque command and the master torque compensation value. In one of the exemplary embodiments, the first inner-loop control module 913 adds the torque command and the master torque compensation value to generate a compensated torque command and then generates a voltage command for controlling the master motor 93 based on the compensated torque command. The master inverter circuit 917 receives the voltage command from the first inner-loop control module 913 and outputs a corresponding three-phase voltage through the switching of the power component to drive the master motor 93 to rotate.

Similar to the master driver 91, the slave driver 92 includes a travel second APR 921, a travel second ASR 922, a second inner-loop control module 923, a travel full closed-loop computation module 924, a PID controller 926, and a slave inverter circuit 927.

The travel full closed-loop computation module 924 generates a corresponding second position feedback based on the slave position feedback of the slave motor 95 received from the slave main-encoder 951 and the auxiliary position feedback of the travel 9 received from the travel auxiliary encoder 94. The travel second APR 921 generates the speed command of the slave motor 95 based on the anti-sway position command received from the controller 41 and the second position feedback received from the travel full closed-loop computation module 924. The travel second ASR 922 generates the torque command that is corresponding to the slave motor 95 based on the speed command received from the travel second APR 921 and the speed feedback of the slave motor 95.

The slave driver 92 is similar to the master driver 91 in that the slave driver 92 receives the slave position feedback from the slave main-encoder 951 through the PID controller 926 or another module (not shown in FIG. 7), receives the master position feedback from the master driver 91 through the communication interface 90, calculates an average value of the slave position feedback and the master position feedback, and then calculates a position error value of the average value and the slave position feedback. Next, the slave driver 92 generates a corresponding slave torque compensation value based on the position error value being calculated through the PID controller 926.

The second inner-loop control module 923 receives the torque command generated by the travel second ASR 922, receives the slave torque compensation value generated by the PID controller 926, and then controls the slave motor 95 to rotate based on the torque command and the slave torque compensation value. In one of the exemplary embodiments, the second inner-loop control module 923 adds the torque command and the slave torque compensation value to generate a compensated torque command and then generates a voltage command for controlling the slave motor 95 based on the compensated torque command. The slave inverter circuit 927 receives the voltage command from the second inner-loop control module 923 and outputs a corresponding three-phase voltage through the switching of the power component to drive the slave motor 95 to rotate.

It should be mentioned that, in the embodiment of FIG. 7, the travel auxiliary-encoder 94 is arranged with respect to a first rail of the main rail and connected to the master driver 91, so that the master driver 91 directly obtains the auxiliary position feedback from the travel auxiliary-encoder 94 while the slave driver 92 needs to be connected to the master driver 91 through the communication interface 90 to obtain the auxiliary position feedback of the travel auxiliary-encoder 94 from the master driver 91. In another embodiment, the travel auxiliary-encoder 94 may be arranged with respect to a second rail of the main rail and connected to the slave driver 92. In the embodiment, the slave driver 92 may directly obtain the auxiliary position feedback from the travel auxiliary-encoder 94 without connecting to the master driver 91 through the communication interface 90. On the other hand, the master driver 91 in this embodiment needs to be connected to the slave driver 92 through the communication interface 90 to obtain the auxiliary position feedback of the travel auxiliary-encoder 94 through the slave driver 92. However, the above descriptions are only few embodiments of the present disclosure, but not limited thereto.

In the embodiment, the multiple modules 911-915 of the master driver 91 and the multiple modules 921-924, 926 may be hardware modules or software modules implemented by electronic circuits in accompanying with program codes.

By utilizing the above motor control architecture, the controller 41 may implement the anti-sway control and the full closed-loop control while controlling the operations of the drivers corresponding to the travel 9, the trolley 8, and the hoist 71. Also, the motor control architecture may implement the torque compensation type's anti-skew control by respectively controlling the master motor 93 and the slave motor 95 by the master driver 91 and the slave driver 92 based on the torque command and the torque compensation value.

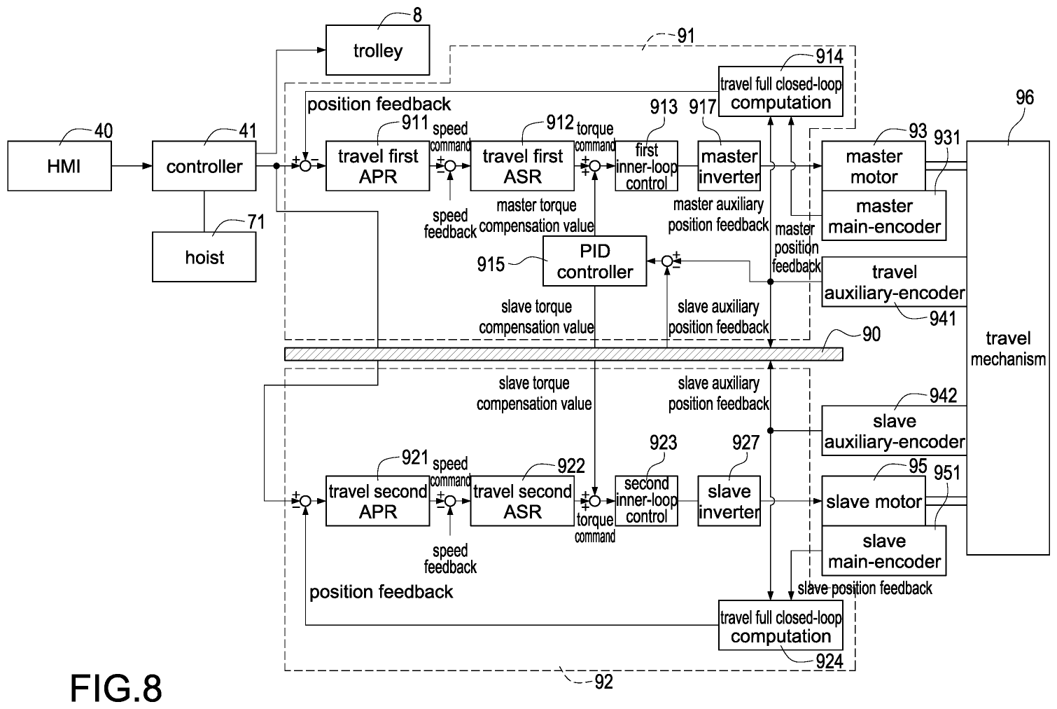

Please refer to FIG. 8, which is a block diagram showing a fourth embodiment of the crane architecture according to the present disclosure. FIG. 8 shows the configuration architecture of the master driver 91 and the slave driver 92 under the torque compensation control mode.

In the embodiment of FIG. 8, the configuration architecture of the master driver 91 and the slave driver 92 is similar to that of the embodiment of FIG. 6. In particularly, the difference between the embodiment of FIG. 8 and the embodiment of FIG. 6 is that, the embodiment of FIG. 8 includes a master auxiliary-encoder 941 arranged with respect to a first rail of the main rail of the travel 9 and a slave auxiliary encoder 942 arranged with respect to a second rail of the main rail of the travel 9. In the embodiment, the master auxiliary-encoder 941 is configured to detect one of the travel wheel sets on the first rail that is controlled by the master motor 93 to generate a corresponding auxiliary position feedback, and the slave auxiliary-encoder 942 is configured to detect another of the travel wheel sets on the second rail that is controlled by the slave motor 95 to generate a corresponding auxiliary position feedback.

As shown in FIG. 8, the master driver 91 includes a travel first APR 911, a travel first ASR 912, a first inner-loop control module 913, a travel full closed-loop computation module 914, a PID controller 915, and a master inverter circuit 917.

The travel full closed-loop computation module 914 receives the master position feedback of the master motor 93 from the master main-encoder 931, receives a master auxiliary position feedback corresponding to the first rail of the travel 9 from the master auxiliary-encoder 941, and generates a corresponding first position feedback based on the master position feedback and the master auxiliary position feedback.

The travel first APR 911 generates the speed command of the master motor 93 based on the anti-sway position command received from the controller 41 and the first position feedback received from the travel full closed-loop computation module 914. The travel first ASR 912 generates the torque command of the master motor 93 based on the speed command received from the travel first APR 911 and the speed feedback of the master motor 93.

In the embodiment, the operation mechanism of the PID controller 915 is different from that as shown in the embodiments of FIG. 6 and FIG. 7. In particularly, in the present embodiment, the PID controller 915 receives the master auxiliary position feedback from the master auxiliary-encoder 941, receives the slave auxiliary position feedback corresponding to the second rail of the travel 9 from the slave auxiliary-encoder 942 through the slave driver 92 and the communication interface 90, and then generates the master torque compensation value for compensating the master motor 93 and the slave torque compensation value for compensating the slave motor 95 based on the master auxiliary position feedback and the slave auxiliary position feedback.

The first inner-loop control module 913 receives the torque command generated by the travel first ASR 912, receives the master torque compensation value generated by the PID controller 915, and controls the master motor 93 to rotate based on the torque command and the master torque compensation value. In one of the exemplary embodiments, the first inner-loop control module 913 adds the torque command of the master motor 93 and the master torque compensation value to generate a compensated torque command and then generates a voltage command for controlling the master motor 93 based on the compensated torque command. The master inverter circuit 917 receives the voltage command from the first inner-loop control module 913 and outputs a corresponding three-phase voltage through the switching of the power component to drive the master motor 93 to rotate.

In the embodiment, the slave driver 92 includes a travel second APR 921, a travel second ASR 922, a second inner-loop control module 923, a travel full closed-loop computation module 924, and a slave inverter circuit 927.

The travel full closed-loop computation module 924 receives the slave position feedback of the slave motor 95 from the slave main-encoder 951, receives the slave auxiliary position feedback corresponding to the second rail of the travel 9 from the slave auxiliary-encoder 942, and generates a corresponding second position feedback based on the slave position feedback and the slave auxiliary position feedback.

The travel second APR 921 generates the speed command of the slave motor 95 based on the anti-sway position command received from the controller 41 and the second position feedback received from the travel full closed-loop computation module 924. The travel second ASR 922 generates the torque command of the slave motor 95 based on the speed command received from the travel second APR 921 and the speed feedback of the slave motor 95.

In the embodiment, the second inner-loop control module 923 receives the torque command of the slave motor 95 from the travel second ASR 922, receives the slave torque compensation value generated by the PID controller 915 from the master driver 91 through the communication interface 90, and then controls the slave motor 95 to rotate based on the torque command of the slave motor 95 and the slave torque compensation value. In one of the exemplary embodiments, the second inner-loop control module 923 adds the torque command and the slave torque compensation value to generate a compensated torque command and then generates a voltage command for controlling the slave motor 95 based on the compensated torque command. The slave inverter circuit 927 receives the voltage command from the second inner-loop control module 923 and outputs a corresponding three-phase voltage through the switching of the power component to drive the slave motor 95 to rotate.

In the embodiment of FIG. 8, the main rail of the travel 9 is arranged with the master auxiliary-encoder 941 corresponding to a first wheel set that is disposed on the first rail and controlled by the master motor 93 and the slave auxiliary-encoder 942 corresponding to a second wheel set that is disposed on the second rail and controlled by the slave motor 95. Therefore, it is unnecessary for the master driver 91 and the slave driver 92 to transmit the master position feedback and the slave position feedback to each other through the communication interface 90, instead, the master driver 91 and the slave driver 92 may directly perform the computation based on the corresponding one of the auxiliary position feedback. In addition, the master driver 91 has considered the master auxiliary position feedback of the master motor 93 and the slave auxiliary position feedback of the slave motor 95 while computing the torque compensation value, so that the master torque compensation value and the slave torque compensation value being generated may be utilized to effectively implement the anti-skew control.

In the aforementioned embodiments, the travel 9 utilizes two drivers to respectively control the master motor 93 and the slave motor 95, so the anti-skew control needs to be performed for the two wheel-axles of the travel 9. However, for the configuration of the bridge cranes or the gantry cranes having a short-span, a single driver is enough for controlling the two motors 93 and 95 of the travel. In this embodiment, the configuration architecture of the travel driver is similar to that of the trolley driver as discussed above, detailed description is provided below.

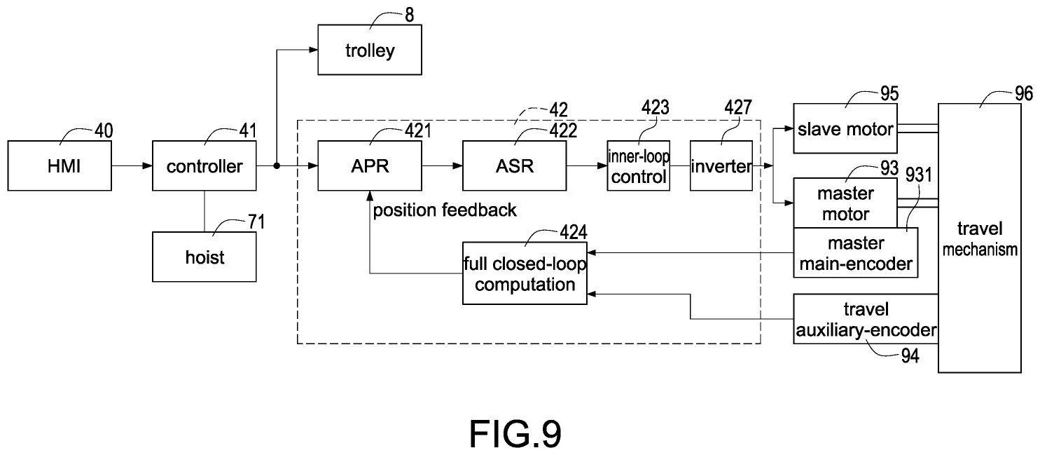

Please refer to FIG. 9, which is a block diagram showing a fifth embodiment of the crane architecture according to the present disclosure. In the embodiment of FIG. 9, the travel 9 includes a single travel driver 42 for controlling both the master motor 93 and the slave motor 95. In particularly, the travel drive 42 is utilized to simultaneously driver the master motor 93 and the slave motor 95 of the travel 9 so that the travel 9 may move on the main rail along the X-axis direction. In the embodiment, at least one of the master motor 93 and the slave motor 95 has a main encoder (such as the master main-encoder 931), and a travel auxiliary-encoder 94 is arranged with respect to the main rail.

The trolley 8 of this embodiment is similar to that as shown in FIG. 5, which includes the trolley driver 81 for controlling a trolley motor 82. The trolley driver 81 may drive the trolley motor 82, so that the trolley 8 may move on a trolley rail that is arranged upon the travel 9 along the Y-axis direction.

The hoist 71 of this embodiment is similar to that as shown in FIG. 5, which is arranged at one side of the trolley 8 and includes the hoist driver 711 for controlling the hoist motor 712. The hoist driver 711 drives the hoist mechanism 713 that is connected with the hoist motor 712, so that the rope on the hoist mechanism 713 may rise and fall along the Z-axis direction, and the hoist driver 711 continuously computes the rope length information of the rope while the rope is controlled to be rising or falling.

Similar to another embodiments, the HMI 40 of this embodiment may receive an external operation from the user to input the target position of the cargo hanged on the crane. The controller 41 is connected to the travel driver 42 of the travel 9, the trolley driver 81, the hoist driver 711, and the HMI 40. The controller 41 performs the path planning process to generate a corresponding position command based on the target position and then computes the anti-sway position command based on the rope length information in accompanying with the position command. The anti-sway position command is identical to the aforementioned embodiments, detailed description is omitted here.

In the embodiment, the travel driver 42 of the travel 9 may perform the full closed-loop computation based on the anti-sway position command, the position feedback of the main-encoder 931 (related to the master motor 93 or the slave motor 95), and the auxiliary position feedback of the travel auxiliary-encoder 94 (related to the travel 9), and controls both the master motor 93 and the slave motor 95 to operate based on the speed command (and the torque command) generated by the full closed-loop computation.

More specifically, in the embodiment of FIG. 9, the travel driver 42 of the travel 9 includes an APR 421, an ASR 422, an inner-loop control module 423, a full closed-loop computation module 424, and an inverter circuit 427.

The full closed-loop computation module 424 receives the position feedback of either the master motor 93 or the slave motor 95 from the main encoder 931, receives the auxiliary position feedback of the travel 9 from the travel auxiliary-encoder 94, and generates a corresponding travel position feedback based on the position feedback and the auxiliary position feedback. The APR 421 generates the speed command for motors of the travel 9 based on the anti-sway position command received from the controller 41 and the travel position feedback received from the full closed-loop computation module 424. The ASR 422 generates a corresponding torque command based on the speed command generated by the travel APR 421. The inner-loop control module 423 receives the torque command generated by the travel ASR 422 and then generates a voltage command for controlling both the master motor 93 and the slave motor 95 based on the torque command. The inverter circuit 427 receives the voltage command from the inner-loop control module 423 and outputs a corresponding three-phase voltage through the switching of the power component to drive both the main motor 93 and the slave motor 95 to rotate.

In the embodiment, the master motor 93, the slave motor 95, and the travel auxiliary-encoder 94 are directly connected to the travel mechanism 96 of the travel 9, so that the travel driver 42 may directly obtain the auxiliary position feedback through the travel auxiliary-encoder 94 and controls the travel mechanism 96 to operate via the master motor 93 and the slave motor 95.

The configuration architecture of the trolley driver 81 is same as that of embodiments discussed above, detailed description is omitted here.

By utilizing the motor control architecture of the present disclosure, the controller and the drivers of the crane may perform the anti-sway control, the full closed-loop control, and the anti-skew control while controlling the multiple motors for the crane to move, so as to resolve the problems that the cargo may sway while the crane moves, the positioning process is imprecise caused by the slippage of the wheel-axles, and the position offset caused by the long-span of the two wheel-axles of the travel.

As the skilled person will appreciate, various changes and modifications can be made to the described embodiment. It is intended to include all such variations, modifications and equivalents which fall within the scope of the present disclosure, as defined in the accompanying claims.

What is claimed is:

1. A motor control architecture of automated cranes, comprising:
a travel disposed across a main rail, comprising a master driver and a slave driver of respectively controlling a master motor and a slave motor for enabling the travel to move on the main rail along an X-axis direction, wherein axles of the master motor and the slave motor respectively comprises a main encoder, and an auxiliary encoder is arranged with respect to the main rail;
a trolley disposed on a trolley rail that is arranged upon the travel, comprising a trolley driver of controlling a trolley motor for enabling the trolley to move on the trolley rail along a Y-axis direction;
a hoist arranged at one side of the trolley, comprising a hoist driver of driving a hoist motor for enabling a rope on a hoist mechanism connected to the hoist motor to rise and fall along a Z-axis direction and continuously calculating a rope length information of the rope;
a human machine interface (HMI), configured to receive an external operation to input a target position; and
a controller connected to the master driver, the slave driver, the trolley driver, the hoist driver, and the HMI, configured to perform a path planning process to generate a position command based on the target position, and computing an anti-sway position command based on the rope length information in accompanying with the position command;
wherein the master driver and the slave driver are configured to respectively perform a full closed-loop computation based on the anti-sway position command, a position feedback of one of the two main encoders, and an auxiliary position feedback of the auxiliary encoder;
wherein the master driver is configured to control the master motor to rotate based on a speed command and a torque command generated by the full closed-loop computation, and the slave driver is configured to follow the speed command and the torque command of the master driver to control the slave motor to rotate; or, the master driver and the slave driver are configured to respectively regard a position error value of the position feedback of one of the two main encoders and the auxiliary position feedback of the auxiliary encoder to be a source of a PID control process to compensate the torque command to generate a compensated torque command, and respectively control the master motor and the slave motor to operate based on the compensated torque command.

2. The motor control architecture of claim 1, wherein the master driver comprises:
a travel first automatic position regulator (APR), configured to receive the anti-sway position command and the position feedback generated by the full closed-loop computation to generate the speed command;
a travel first automatic speed regulator (ASR), configured to receive the speed command from the travel first APR to generate the torque command correspondingly;
a first inner-loop control module, configured to receive the torque command and generate a first voltage command based on the torque command; and
a master inverter circuit, configured to receive the first voltage command from the first inner-loop control module and control the master motor to rotate based on the first voltage command.

3. The motor control architecture of claim 2, wherein the slave driver comprises:
a speed computation module, configured to receive a slave position feedback of the slave motor from a slave main-encoder of the slave motor to generate a speed feedback correspondingly;
a hysteresis limiter, configured to receive the speed command from the travel first APR to be a reference speed and generate a second speed command correspondingly based on the reference speed and the speed feedback;
a travel second ASR, configured to receive the second speed command from the hysteresis limiter to generate a second torque command correspondingly;
a second inner-loop control module, configured to receive the torque command from the travel first ASR to be a reference torque, receive the second torque command from the travel second ASR, and generate a second voltage command based on the reference torque and the second torque command; and
a slave inverter circuit, configured to receive the second voltage command from the second inner-loop control module and control the slave motor to rotate based on the second voltage command.

4. The motor control architecture of claim 1, wherein the master driver comprises:
a first full closed-loop computation module, configured to receive master position feedback of the master motor from a master main-encoder of the master motor, receive the auxiliary position feedback from the auxiliary encoder, and generate first position feedback correspondingly;
a travel first automatic position regulator (APR), configured to receive the anti-sway position command and the first position feedback to generate the speed command of the master motor;
a travel first automatic speed regulator (ASR), configured to receive the speed command of the master motor from the travel first APR and generate the torque command of the master motor based on the speed command of the master motor and speed feedback of the master motor;
a PID controller, configured to receive the master position feedback from the master main-encoder, receive a slave position feedback from the slave driver, and generate a master torque compensation value of controlling the master motor and a slave torque compensation value of controlling the slave motor;
a first inner-loop control module, configured to receive the torque command of the master motor from the travel first ASR, receive the master torque compensation value from the PID controller, and generate a first voltage command based on the torque command and the master torque compensation value of the master motor; and
a master inverter circuit, configured to receive the first voltage command from the first inner-loop control module and control the master motor to rotate based on the first voltage command.

5. The motor control architecture of claim 4, wherein the slave driver comprises:
a second full closed-loop computation module, configured to receive the slave position feedback from a slave main-encoder of the slave motor, receive the auxiliary position feedback from the auxiliary encoder, and generate a second position feedback correspondingly;
a travel second APR, configured to receive the anti-sway position command and the second position feedback to generate a speed command of the slave motor;
a travel second ASR, configured to receive the speed command of the slave motor from the travel second APR and generate a torque command of the slave motor based on the speed command of the slave motor and speed feedback of the slave motor;
a second inner-loop control module, configured to receive the torque command of the slave motor from the travel second ASR, receive the slave torque compensation value from the PID controller, and generate a second voltage command based on the torque command and the slave torque compensation value of the slave motor; and
a slave inverter circuit, configured to receive the second voltage command from the second inner-loop control module to control the slave motor to rotate based on the second voltage command.

6. The motor control architecture of claim 1, wherein the master driver comprises:
a first full closed-loop computation module, configured to receive a master position feedback of the master motor from a master main-encoder of the master motor, receive the auxiliary position feedback from the auxiliary encoder, and generate a first position feedback correspondingly;
a travel first automatic position regulator (APR), configured to receive the anti-sway position command and the first position feedback to generate the speed command of the master motor;
a travel first automatic speed regulator (ASR), configured to receive the speed command of the master motor from the travel first APR, and generate the torque command of the master motor based on the speed command of the master motor and speed feedback of the master motor;
a first PID controller, configured to receive the master position feedback from the master main-encoder, receive a slave position feedback from the slave driver, calculate an average value of the master position feedback and the slave position feedback, and generate a master torque compensation value based on a position error value of the average value and the master position feedback;
a first inner-loop control module, configured to receive the torque command of the master motor from the travel first ASR, receive the master torque compensation value from the first PID controller, and generate a first voltage command based on the torque command and the master torque compensation value of the master motor; and
a master inverter circuit, configured to receive the first voltage command from the first inner-loop control module to control the master motor to rotate based on the first voltage command.

7. The motor control architecture of claim 6, wherein the slave driver comprises:
a second full closed-loop computation module, configured to receive the slave position feedback from a slave main-encoder of the slave motor, receive the auxiliary position feedback from the auxiliary encoder, and generate a second position feedback correspondingly;
a travel second APR, configured to receive the anti-sway position command and the second position feedback to generate a speed command of the slave motor;
a travel second ASR, configured to receive the speed command of the slave motor from the travel second APR and generate a torque command of the slave motor based on the speed command of the slave motor and speed feedback of the slave motor;
a second PID controller, configured to receive the slave position feedback from the slave main-encoder, receive the master position feedback from the master driver, calculate an average value of the slave position feedback and the master position feedback, and generate a slave torque compensation value based on a position error value of the average value and the slave position feedback;
a second inner-loop control module, configured to receive the torque command of the slave motor from the travel second ASR, receive the slave torque compensation value from the second PID controller, and generate a second voltage command based on the torque command and the slave torque compensation value of the slave motor; and
a slave inverter circuit, configured to receive the second voltage command from the second inner-loop control module to control the slave motor to rotate based on the second voltage command.

8. The motor control architecture of claim 1, wherein the travel comprises a first wheel set controlled by the master motor and a second wheel set controlled by the slave motor, the main rail comprises a first rail enabling the first wheel set to move and a second rail enabling the second wheel set to move, the auxiliary encoder comprises a master auxiliary-encoder and a slave auxiliary-encoder, wherein the master auxiliary-encoder is arranged with respect to the first rail and configured to detect the first wheel set to generate a master auxiliary position feedback, and the slave auxiliary-encoder is arranged with respect to the second rail and configured to detect the second wheel set to generate a slave auxiliary position feedback.

9. The motor control architecture of claim 8, wherein the master driver comprises:
a first full closed-loop computation module, configured to receive a master position feedback of the master motor from a master main-encoder of the master motor, receive the master auxiliary position feedback from the master auxiliary-encoder, and generate a first position feedback correspondingly;
a travel first automatic position regulator (APR), configured to receive the anti-sway position command and the first position feedback to generate the speed command of the master motor;
a travel first automatic speed regulator (ASR), configured to receive the speed command of the master motor from the travel first APR and generate the torque command of the master motor based on the speed command of the master motor and speed feedback of the master motor;
a PID controller, configured to receive the master auxiliary position feedback from the master auxiliary-encoder, receive the slave auxiliary position feedback from the slave auxiliary-encoder, and generate a master torque compensation value of controlling the master motor and a slave torque compensation value of controlling the slave motor;
a first inner-loop control module, configured to receive the torque command of the master motor from the travel first ASR, receive the master torque compensation value from the PID controller, and generate a first voltage command based on the torque command and the master torque compensation value of the master motor; and
a master inverter circuit, configured to receive the first voltage command from the first inner-loop control module to control the master motor to rotate based on the first voltage command.

10. The motor control architecture of claim 9, wherein the slave driver comprises:
a second full closed-loop computation module, configured to receive a slave position feedback of the slave motor from a slave main-encoder of the slave motor, receive the slave auxiliary position feedback from the slave auxiliary-encoder, and generate a second position feedback correspondingly;
a travel second APR, configured to receive the anti-sway position command and the second position feedback to generate a speed command of the slave motor;
a travel second ASR, configured to receive the speed command of the slave motor from the travel second APR and generate a torque command of the slave motor based on the speed command of the slave motor and speed feedback of the slave motor;
a second inner-loop control module, configured to receive the torque command of the slave motor from the travel second ASR, receive the slave torque compensation value from the PID controller, and generate a second voltage command based on the torque command and the slave torque compensation value of the slave motor; and
a slave inverter circuit, configured to receive the second voltage command from the second inner-loop control module to control the slave motor to rotate based on the second voltage command.

11. The motor control architecture of claim 1, wherein the trolley driver comprises:
a trolley full closed-loop computation module, configured to receive a position feedback of the trolley motor from a trolley main-encoder of the trolley motor, receive a trolley auxiliary position feedback from a trolley auxiliary-encoder, and generate a trolley position feedback correspondingly, wherein the trolley auxiliary-encoder is arranged with respect to the trolley rail and configured to detect the trolley to generate the trolley auxiliary position feedback;
a trolley automatic position regulator (APR), configured to receive the anti-sway position command and the trolley position feedback to generate a speed command of the trolley;
a trolley automatic speed regulator (ASR), configured to receive the speed command of the trolley from the trolley APR and generate a torque command of the trolley based on the speed command of the trolley;
a trolley inner-loop control module, configured to receive the torque command of the trolley from the trolley ASR and generate a voltage command based on the torque command of the trolley; and
a trolley inverter circuit, configured to receive the voltage command from the trolley inner-loop control module to control the trolley motor to rotate based on the voltage command.

12. The motor control architecture of claim 1, wherein software or hardware for performing the full closed-loop computation comprises:
an encoder gear-rate computation module, configured to compute a ratio of a pulse feedback of the auxiliary encoder generated while the master motor or the slave motor rotates and a resolution of a master motor-encoder or a slave motor-encoder corresponding to one of the master motor and the slave motor which is rotating; and
a low-pass filter, configured to compute a difference value of the auxiliary position feedback of the auxiliary encoder and the ratio, and perform a filtering process to the difference value to generate an equivalent position feedback, wherein the speed command is generated based on the equivalent position feedback.

13. The motor control architecture of claim 1, wherein the path planning process comprises obtaining a current position, a relay position, and the target position, wherein the anti-sway position command is a cyclic synchronous position (CSP) command.

14. The motor control architecture of claim 13, wherein the path planning process further comprises obtaining position information of a forbidden region or an obstacle.

15. The motor control architecture of claim 1, further comprising a communication interface, wherein the master driver and the slave driver have a wired connection or a wireless connection through the communication interface.

16. The motor control architecture of claim 15, wherein the travel comprises a first wheel set being controlled by the master motor and a second wheel set being controlled by the slave motor, the main rail comprises a first rail for the first wheel set to move and a second rail for the second wheel set to move, wherein the auxiliary encoder is arranged with respect to the first rail and configured to detect the first wheel set to generate the auxiliary position feedback to be provided to the main driver, and the slave driver obtains the auxiliary position feedback from the master driver through the communication interface.

17. The motor control architecture of claim 15, wherein the travel comprises a first wheel set being controlled by the master motor and a second wheel set being controlled by the slave motor, the main rail comprises a first rail for the first wheel set to move and a second rail for the second wheel set to move, wherein the auxiliary encoder is arranged with respect to the second rail and configured to detect the second wheel set to generate the auxiliary position feedback to be provided to the slave driver, and the master driver obtains the auxiliary position feedback from the slave driver through the communication interface.

18. A motor control architecture of automated cranes, comprising:
a travel disposed across a main rail, comprising a travel driver of controlling both a master motor and a slave motor for enabling the travel to move on the main rail along an X-axis direction, wherein an axle of the master motor comprises a main encoder, and the main rail comprises an auxiliary encoder;
a trolley disposed on a trolley rail that is arranged upon the travel, comprising a trolley driver of controlling a trolley motor for enabling the trolley to move on the trolley rail along a Y-axis direction;
a hoist arranged at one side of the trolley, comprising a hoist driver of driving a hoist motor for enabling a rope on a hoist mechanism connected to the hoist motor to rise and fall along a Z-axis direction and continuously calculating a rope length information of the rope;
a human machine interface (HMI), configured to receive an external operation to input a target position; and
a controller connected to the travel driver, the trolley driver, the hoist driver, and the HMI, configured to perform a path planning process to generate a position command based on the target position, and computing an anti-sway position command based on the rope length information in accompanying with the position command;
wherein the travel driver is configured to perform a full closed-loop computation based on the anti-sway position command, a position feedback of the main encoder, and a travel auxiliary position feedback of the auxiliary encoder, and control both the master motor and the slave motor based on a speed command and a torque command generated by the full closed-loop computation.

19. The motor control architecture of claim 18, wherein the travel driver comprises:
a travel full closed-loop computation module, configured to receive the position feedback of the travel from the main encoder, receive the travel auxiliary position feedback from the auxiliary encoder, and generate a travel position feedback correspondingly;
a travel automatic position regulator (APR), configured to receive the anti-sway position command and the travel position feedback to generate the speed command of the travel;
a travel automatic speed regulator (ASR), configured to receive the speed command of the travel from the travel APR and generate the torque command of the travel based on the speed command of the travel to control both the master motor and the slave motor to rotate.

20. The motor control architecture of claim 18, wherein the trolley driver comprises:
a trolley closed-loop computation module, configured to receive a position feedback of the trolley motor from a trolley main-encoder of the trolley motor, receive a trolley auxiliary position feedback from a trolley auxiliary-encoder, and generate a trolley position feedback correspondingly, wherein the trolley auxiliary-encoder is arranged with respect to the trolley rail and configured to detect the trolley to generate the trolley auxiliary position feedback;
a trolley automatic position regulator (APR), configured to receive the anti-sway position command and the trolley position feedback to generate a speed command of the trolley; and
a trolley automatic speed regulator (ASR), configured to receive the speed command of the trolley from the trolley APR and generate a torque command of the trolley based on the speed command of the trolley to control the trolley motor to rotate.
